(19) United States
(12) Patent Application Publication
(10) Pub. No.: US 2026/0100201 A1
(43) Pub. Date: Apr. 9, 2026

(54) HIGH-CAPACITY MEDIA LIBRARY

(71) Applicant: Quantum Corporation, Centennial, CO (US)

(72) Inventor: Carsten Hermann Prigge, Elizabeth, CO (US)

(73) Assignee: Quantum Corporation, Centennial, CO (US)

(21) Appl. No.: 18/911,148

(22) Filed: Oct. 9, 2024

(51) Int. Cl. G11B 23/023; B25J 9/16

(52) U.S. Cl. CPC G11B 23/023; B25J 9/1679

(57) ABSTRACT

Systems and techniques for providing more storage capacity in a media library. The media library may include a plurality of media cartridge storage slots in a plurality of storage magazines. The media library may include a robotic picker device for retrieving media cartridges from the media cartridge storage slots. The media cartridge storage slots may be dual-cartridge storage slots configured to hold two media cartridges and/or the robotic picker device may be a dual-slot robotic picker device.

### BACKGROUND

Automated media library systems (or “media libraries), such as automated tape library systems (or “tape libraries), are commonly utilized for purposes of writing data to and reading data from media cartridges, such as magnetic tape cartridges configured to retain and/or store magnetic tape that can be used in a magnetic tape drive for purposes of reading and writing data.

### SUMMARY

Some embodiments provide for a media library system. The media library system comprises a frame; a media storage portion supported by the frame, the media storage portion comprising: at least one column of media cartridge storage magazines, wherein at least some of the storage magazines comprise multiple dual-cartridge storage slots; a media drive portion supported by the frame, the media drive portion comprising a plurality of media drives, each particular drive of the plurality of media drives being configured to read data from a media cartridge when the media cartridge is inserted into the particular drive, and a robotic picker device supported by the frame and configured to selectively retrieve a media cartridge stored in the media storage portion and place the media cartridge into one of the plurality of media drives.

Some embodiments provide for a media library system. The media library system comprises a frame; a media storage portion supported by the frame, the media storage portion comprising: a first column of media cartridge storage magazines, and a second column of media cartridge storage magazines, wherein media cartridge storage magazines in the first column and the second column comprise multiple dual-cartridge storage slots configured to receive two media cartridges; a media drive portion supported by the frame, the media drive portion comprising a plurality of media drives, each media drive of the plurality of media drives being configured to read data from a media cartridge when the media cartridge is inserted into the media drive; and a robotic picker device supported by the frame and configured to move in an interior space of the media library and selectively retrieve a media cartridge stored in the media storage portion and place the media cartridge into one of the plurality of media drives, the robotic picker device comprising: a first slot configured to receive a first media cartridge and a second slot configured to receive a second media cartridge.

Some embodiments provide for a method performed by a media library system, the media library system comprising a plurality of media cartridge storage magazines arranged in at least one column, with at least some of the storage magazines having multiple dual-cartridge storage slots configured to receive media cartridges, one or more media drives, and a robotic picker device. The method comprises moving, with the robotic picker device, a first media cartridge from a first dual-cartridge storage slot into a first slot of the robotic picker device, the first media cartridge being in a first portion of the first dual-cartridge storage slot; moving the robotic picker device to align a second slot of the robotic picker device with the first dual-cartridge storage slot; moving, with the robotic picker device, a second media cartridge from the first dual-cartridge storage slot into the second slot of the robotic picker device, the second media cartridge being in a second portion of the first dual-cartridge storage slot; moving the robotic picker device to align the second slot with a first media drive of the one or more media drives; and moving, with the robotic picker device, the second media cartridge into the first media drive of the one or more media drives.

### BRIEF DESCRIPTION OF THE DRAWINGS

Various aspects and embodiments will be described herein with reference to the following figures. It should be appreciated that the figures are not necessarily drawn to scale, Items appearing in multiple figures are indicated by the same or similar reference number in all the figures in which they appear,

FIG. 1 depicts an example media library system, according to some embodiments.

FIG. 2A depicts an exploded perspective view of the example media library system of FIG. 1, according to some embodiments.

FIG. 2B depicts a front view of the example media library system with dimensions to fit within sizing standards set by a storage facility, according to some embodiments.

FIG. 2C depicts a top view of the example media library system with dimensions to fit within sizing standards set by a storage facility, according to some embodiments.

FIG. 3 is a block diagram showing a top view of an example media library system, according to some embodiments.

FIG. 4 depicts a perspective view of an example media cartridge storage magazine for use in a media library system, according to some embodiments,

FIG. 5 depicts a cross-sectional view of a portion of an example media cartridge storage magazine, according to some embodiments.

FIG. 6 depicts an example dual-slot robotic picker device for use in a media library system, according to some embodiments.

FIG. 7A depicts a perspective view of a media cartridge storage slot and a robotic picker device in a first position, according to some embodiments.

FIG. 7B depicts a perspective view of a media cartridge storage slot and a robotic picker device in a second position, according to some embodiments.

FIG. 7C depicts a perspective view of a media cartridge storage slot and a robotic picker device in a third position, according to some embodiments.

FIG. 8 is a flow chart for an example process of retrieving a media cartridge from a media cartridge storage slot of a media library, according to some embodiments.

FIG. 9 shows a block diagram of an example computing device that may be used to implement embodiments of the technology described herein, according to some embodiments,

### DETAILED DESCRIPTION

Automated media library systems (or “media libraries”), such as automated tape library systems (or “tape libraries”), are commonly utilized for purposes of writing data to and reading data from media cartridges, such as tape cartridges or magnetic tape cartridges. Media cartridges are configured to retain and/or store a storage medium that can be used in a media drive for purposes of writing data to and reading data from the storage medium. In some media libraries, tape cartridges have been used because they provide a convenient way to house and support a length of tape for engagement by a transducer (or tape head, sometimes referred to as a “head”) in the tape drive while protecting the magnetic tape upon removal of the tape cartridge. Moreover, tape cartridges facilitate economic and compact storage of data. During use of the tape drive, a tape head of the tape drive is configured to be in direct contact with the tape from the magnetic tape cartridge so that data can be written to and read from the tape as the tape moves across the tape head, often at high speed. Such tape heads can include dedicated write heads, dedicated read heads, or combination read/write heads. However, the technology is not limited in this respect and the media cartridges may be compact discs, optical discs, video home system (VHS) tapes, digital video discs (DVDs), solid state drives like flash drives or hard drives, or other suitable forms of media cartridges configured to store data.

The media cartridges are received and retained (and stored) within storage slots of the media library when not being used for purposes of writing data to and/or reading data from the media cartridge. In various embodiments, the media library can include a plurality of storage slots that are incorporated within one or more magazines. When it is desired to perform a write operation and/or a read operation on the storage medium within a given media cartridge, such as upon request of a user or host application, a media cartridge retrieval assembly (also referred to herein as a “retrieval assembly”) of the tape library is used to retrieve the media cartridge and move the media cartridge between the storage slot and a media drive of the media library. In many embodiments, the retrieval assembly includes a robotic picker device having a pair of picker fingers that are configured to selectively grasp the media cartridge for purposes of moving the media cartridge between the storage slot and the media drive. Upon completion of the desired write operation and/or read operation, the retrieval assembly and/or the robotic picker device can then return the media cartridge to an appropriate storage slot.

The inventors have recognized that it is desirable to increase the storage capacity of storage facilities, which hold multiple media libraries. Storage facilities typically arrange multiple media libraries in a defined space, with each media library having the same or similar size and configuration. For example, many storage facilities store media libraries having the same width, for example, of approximately 600 millimeters. Limiting the physical footprint of the media libraries stored within a storage facility to a width of approximately 600 millimeters (or other fixed predetermined width) ultimately limits the storage capacity of the storage facility as a whole because there will be a maximum number of media libraries that the storage facility will be able to contain. Once at that limit, adding more media libraries to the storage facility is not possible and therefore not a route for increasing its capacity. Instead, in order to increase the storage capacity of a storage facility, the storage capacity of individual media libraries has to be increased. And, to this end, the inventors have developed a new type of media library which both: (i) has higher storage capacity than conventional media library systems; and (ii) conforms to sizing limitations that a storage facility may employ.

Conventional approaches to media library design employ tight design of single cartridge storage slots arranged in magazines that are typically mounted to a frame of the media library. The mounting features limit the amount of interior space in the media library and, therefore, limit the amount of usable storage space in the library. Because of the dimensional requirements set by various storage facilities, increasing capacity in the media library while adhering to the dimensional requirements is difficult. Previous conventional approaches to increasing the capacity of a media storage library face similar problems of having features that reduce the internal usable storage space of the media library. Namely, some approaches have used a single column setup having magazines with multi-cartridge (e.g., 6-8 cartridge) storage slots. These approaches limit the accessibility to the media cartridges stored in the rear of the multi-cartridge storage slot and require intermediate storage areas to be used during retrieval of rearward cartridges in a slot (e.g., in a 7-cartridge storage slot, 6 cartridges need to be retrieved and stored in an intermediate space while the 7^{th}—rearmost—cartridge is retrieved). This not only requires that some space in the media library be used for intermediate storage of cartridges during retrieval (which in turn reduces the amount of storage slots used for storage and therefore reduces the capacity of the media library), but also increases the amount of time needed to retrieve a media cartridge delaying the time by which data stored on the media cartridge can be read.

To address some of the aforementioned problems of conventional media libraries, the inventors have developed a new type of media library that has a higher capacity than conventional media library designs while nonetheless conforming to sizing requirements of storage facilities. The media library utilizes dual-cartridge storage slots rather than the single-cartridge and multi-cartridge slots of conventional approaches. In that way, each storage slot has increased capacity while minimizing any swapping that needs to be done to reach the rearward media cartridges. In addition, the media library utilizes a dual-slot robotic picker device that can retrieve two media cartridges without using an intermediate storage area to perform any swapping. To facilitate the dual-cartridge slots and robotic picker device in the restricted dimensions set by a storage facility, the magazines used to house the dual-cartridge slots can be stackable in the frame of the media library so that the magazines may be slid into the frame without any additional mounting features restricting the available space. Further, the robotic picker device has a rotatable head so that it can effectively move throughout the media library to access any media cartridge stored in the library without being impeded by the other components in the media library. The media library systems utilizing the techniques described above and further herein may enable the capacity to increase over conventional approaches by 500 to 1000 media cartridges. For example, the conventional media library systems utilizing single cartridge storage slots may hold up to 1000 media cartridges and the conventional increased capacity library systems that require swapping space may only increase the capacity of the media storage library to 1500 media cartridges. However, the media library systems employing the techniques described herein may enable storage of up to 2000 media cartridges or more while still conforming to sizing standards set by storage facilities.

Accordingly, some embodiments provide for a media library system comprising: (a) a frame (e.g., having a width of 600 millimeters); (b) a media storage portion supported by the frame, the media storage portion comprising: at least one column of (e.g., stacked) media cartridge storage magazines (e.g., in magazine openings extending through the frame), wherein at least some of the storage magazines comprise multiple dual-cartridge storage slots (e.g., dual tape-cartridge storage slots); (c) a media drive portion supported by the frame, the media drive portion comprising a plurality of media drives, each particular drive of the plurality of media drives being configured to read data from a media cartridge when the media cartridge is inserted into the particular drive; and (d) a robotic picker device (e.g., having two slots to hold two media cartridges) supported by the frame and configured to selectively retrieve a media cartridge stored in the media storage portion and place the media cartridge into one of the plurality of media drives. In this configuration, the media library system provides increased capacity while adhering to dimensional standards set by a storage facility (e.g., having to fit into 600 mm wide rack spaces). By using dual-cartridge storage slots and a robotic picker device configured to work with the dual-cartridge storage slots (e.g., by having two storage slots), the media library system provides increases capacity and maintains accessibility to each of the media cartridges stored in the media library.

In some embodiments, the at least one column of media cartridge storage magazines comprises: (i) a first column of media cartridge storage magazines, each comprising multiple dual-cartridge storage slots; and (ii) a second column of media cartridge storage magazines, each comprising multiple dual-cartridge storage slots. Unlike conventional solutions which have only one column having storage slots that are more than two cartridges deep and may require additional intermediate storage areas to access cartridges deeper in the column (e.g., four or more storage portions deep), this provides easier access to the media cartridges within shallower storage slots (e.g., two storage portions deep), Further, in embodiments with a dual-slot robotic picker device, the picker device may access the more rearward media cartridge without using any intermediate storage areas.

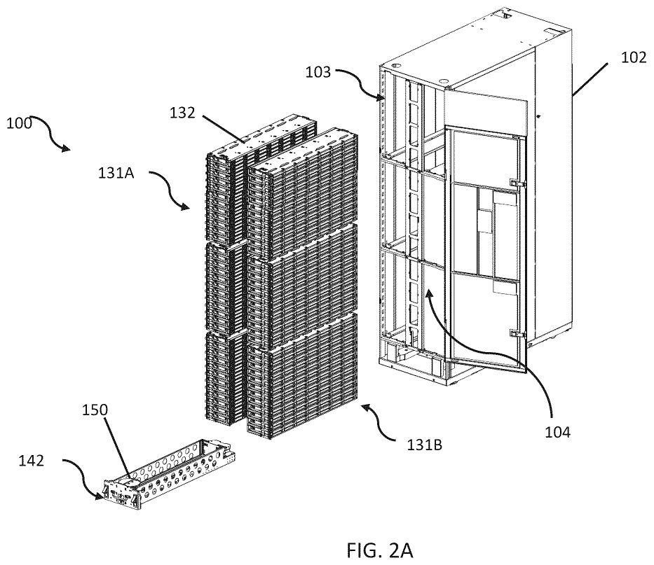

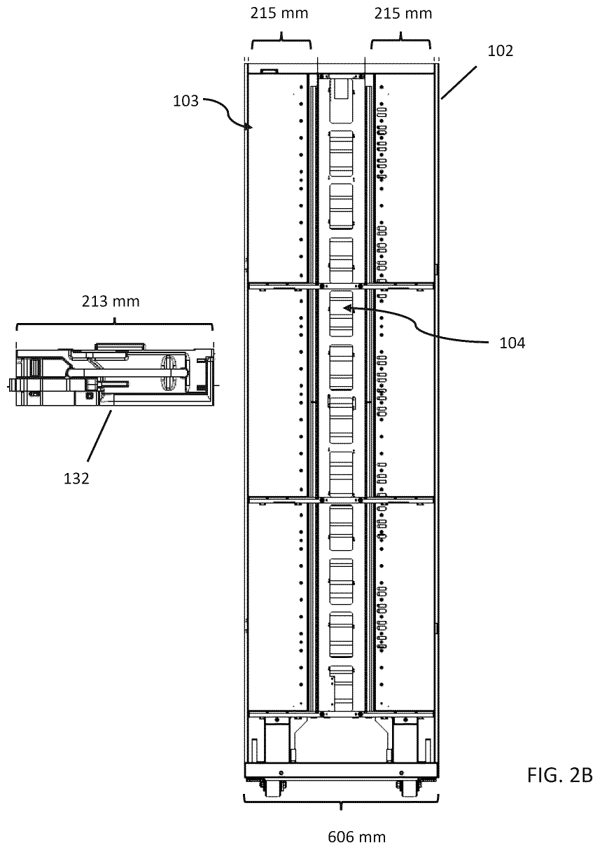

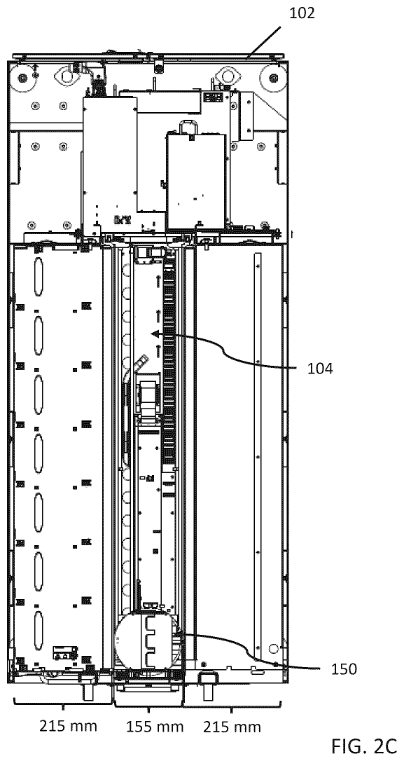

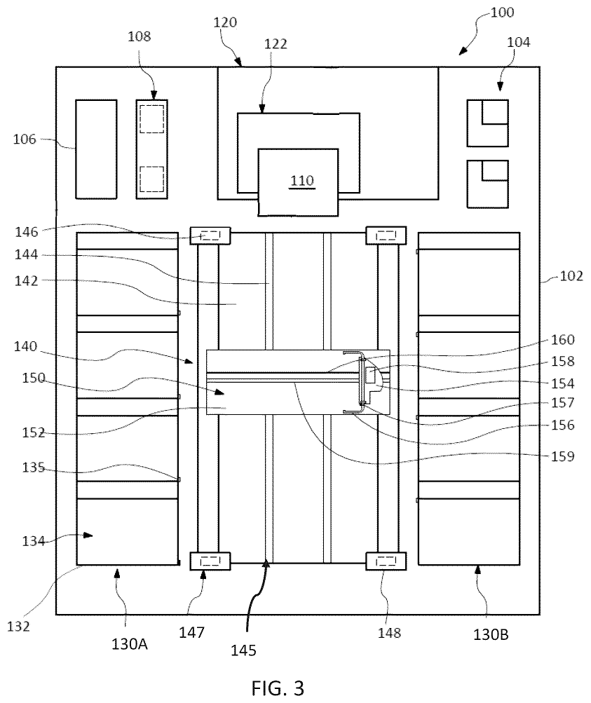

In some embodiments, the robotic picker device is configured to move in an interior space (e.g., interior space 104 of FIGS. 2 and 3) of the media library (e.g., between the first and second columns of media cartridge storage magazines), and (i) openings of the dual cartridge storage slots in the first column of media cartridge storage magazines through which media cartridges pass during retrieval or placement in the dual-cartridge storage slots, are facing the interior space, (ii) openings of dual-cartridge storage slots in the second column of media storage magazines, through which media cartridges pass during retrieval or placement in the dual-cartridge storage slots, are facing the interior space, and (iii) openings of the plurality of media drives, through which media cartridges pass during retrieval or placement in the media drives, are facing the interior space.

In some embodiments, the robotic picker device has a rotatable head having a slot on a first side of the rotatable head and configured to receive a media cartridge, wherein the rotatable head is configured to rotate between a first orientation in which the first side is facing the first column, a second orientation in which the first side is facing the second column, and a third orientation in which the first side is facing the plurality of media drives. In that way, the robotic picker device may move throughout the media library system to access media cartridges in any of the storage slots, even when the dimensions of the media library system are restricted by storage facility standards.

In some embodiments, each dual-cartridge storage slot comprises a first portion configured to retain (e.g., by using a latch) a first media cartridge and a second portion configured to retain a second media cartridge, the second portion being accessible through the first portion. In some embodiments, each dual-cartridge storage slot comprises a spring-loaded mechanism configured to bias the second media cartridge in the second portion towards the first portion. By providing access to both cartridges in the storage slot through the same opening, only one robotic picker device may be needed to access any of the media cartridges in the media library system. A spring-loaded mechanism (e.g., spring-loaded mechanism 136 of FIG. 3) additionally provides easier access to media cartridges stored in the rearward portion of the storage slot.

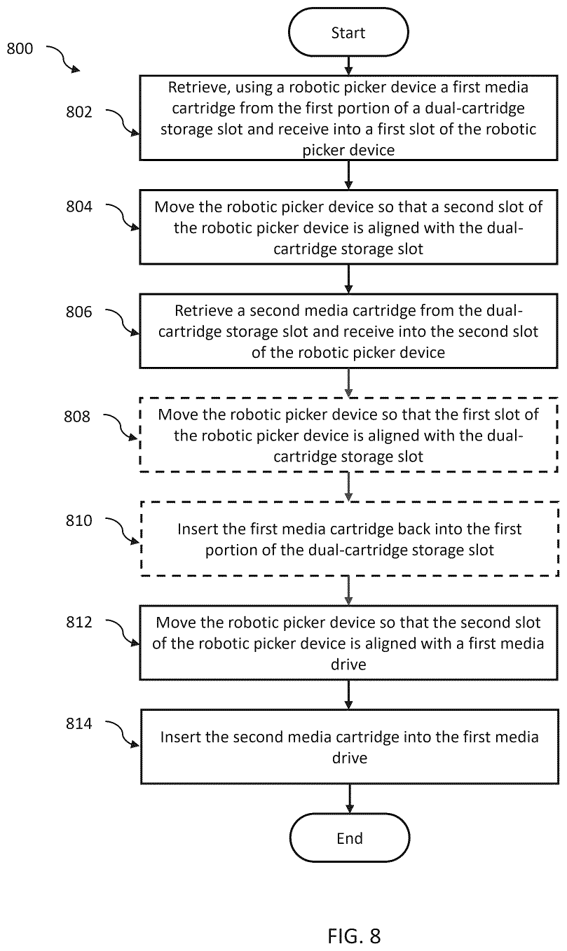

Some embodiments provide for a method (e.g., as described with respect to FIG. 8) performed by a media library system, the media library system comprising a plurality of media cartridge storage magazines arranged in at least one column, with at least some of the storage magazines having multiple dual-cartridge storage slots configured to receive media cartridges, one or more media drives, and a robotic picker device. The method comprises (a) moving, with the robotic picker device (e.g., a dual-slot picker device), a first media cartridge from a first dual-cartridge storage slot into a first slot of the robotic picker device, the first media cartridge being in a first portion of the first dual-cartridge storage slot; (b) moving the robotic picker device to align a second slot of the robotic picker device with the first dual-cartridge storage slot; (c) moving, with the robotic picker device, a second media cartridge from the first dual-cartridge storage slot into the second slot of the robotic picker device, the second media cartridge being in a second portion of the first dual-cartridge storage slot (e.g., the second media cartridge may be biased towards the first portion by a spring-loaded mechanism); (d) moving the robotic picker device (e.g., at least by rotating a rotatable head of the picker device) to align the second slot with a first media drive of the one or more media drives; and (e) moving, with the robotic picker device, the second media cartridge into the first media drive of the one or more media drives. The dual-slot picker provides easier access to media cartridges in the rear, second portion of the dual-cartridge storage slot without using any intermediate storage areas that may otherwise take up and restrict usable space in the media library as with conventional approaches.

It should be appreciated that the embodiments described herein may be implemented in any numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

Some embodiments described herein address all the above-described issues that the inventors have recognized with conventional media library systems. However, it should be appreciated that not every embodiment described herein addresses every one of these issues. It should also be appreciated that embodiments of the technology described herein may be used for purposes other than addressing the above discussed problems with conventional media library systems.

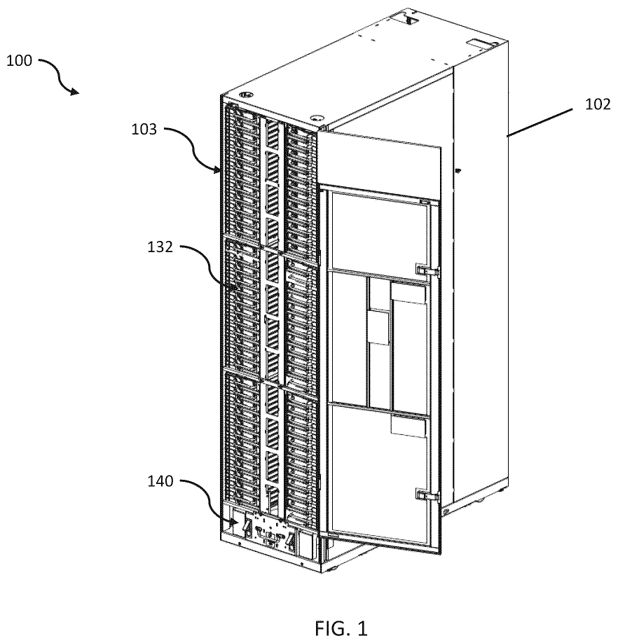

FIG. 1 depicts an example media library system 100, according to some embodiments. The media library system 100 includes a frame 102 having a plurality of magazine openings 103, a plurality of media cartridge storage magazines 132 in the plurality of magazine openings, and a media retrieval assembly 150. Media library system 100 may further include a media drive system (not pictured) supported by frame 102, having one or more media drives configured to read data from and write data to the storage medium of the media cartridges stored in the media library. As discussed above, the frame 102 may be of a particular size to be stored within a particular storage facility according to the sizing limitations of the particular storage facility. For example, frame 102 may have a particular width to fit according to the storage facility's standards. In some embodiments, the width of frame 102 may be 600 millimeters. However, the technology is not limited in that respect, and the width may vary depending on the size standards of the particular storage facility. For example, in some embodiments the width of frame 102 may be approximately 200 mm, 400 mm, 600 mm, 800 mm, 1000 mm, or any other suitable width. In some embodiments, the width of frame 102 may be between 200 mm-600 mm, 400 mm-600 mm, 600 mm-1000 mm, or within any suitable range.

FIG. 2A depicts an exploded perspective view of the example media library system 100 of FIG. 1, according to some embodiments. Frame 102 has a plurality of magazine openings 103 configured to receive a plurality of media cartridge storage magazines 132 for storage and use in the media library system. The magazine openings 103 may extend from a front end to a back end of frame 102 so that the media cartridge storage magazines may be received into magazine openings 103. In some embodiments, each magazine opening 103 may be configured to receive a respective media cartridge storage magazine 132. In other embodiments, each magazine opening 103 may receive two or more media cartridge storage magazines 132. In some embodiments, frame 102 may house the media drive system at the rear end of frame 102 so that magazine openings 103 may extend from the front end of frame 102 to the media drive system.

Magazine openings 103 may include one or more attachment or mounting features (not pictured) for securing the media cartridge storage magazines 132 into the openings, the attachment or mounting features at least partially defining the boundaries of each magazine opening 103. However, to increase available storage space and usable width within the interior of the media library, in some embodiments, magazine openings 103 may not include any attachment or mounting features and the media cartridge storage magazines 132 may be configured to be stacked on top of other media cartridge storage magazines 132 within the magazine openings 103. As such, media cartridge storage magazines 132 may be arranged in columns. For example, as depicted in FIG. 2, media cartridge storage magazines 132 are arranged in a first column 131A and a second column 131B. However, any suitable configuration of media cartridge storage magazines may be employed for storing media cartridges in the media library. Media cartridge storage magazines 132 may have a plurality of media cartridge storage slots configured in any suitable manner to receive and storage one or more media cartridges in the media library, details of which will be described further herein,

Media library 100 further includes a media retrieval assembly 140 for facilitating one or more functions of media library 100. For example, media retrieval assembly 140 may be configured to retrieve one or more media cartridges from media cartridge storage magazines 132 and move the retrieved media cartridge to one of the media drives in the media drive system, and vice versa. In some embodiments, retrieval assembly 140 includes a movable robotic picker device 150, and related assembly support structures such as assembly base 142, one or more support racks, one or more guide rails, or any other suitable support structures, details of which will be described further herein. Robotic picker device 150 may be configured to move in an interior space 104 of frame 102 to move one or more media cartridges to and from the media cartridge storage slots of media cartridge magazines 132 and one or more media drives of the media drives system. In some embodiments, robotic picker device 150 may be configured to move laterally, longitudinally, and/or vertically so that it may access and retrieve media cartridges from any media cartridge storage slot in the library, In some embodiments, at least a portion (e.g., a head portion) of robotic picker device 150 may be rotatable so that it may access and retrieve media cartridges from both column 131A and 131B, as well as rotate to face the media drive system to insert or retrieve a media cartridge in a media drive of the drive system.

As discussed above, the media library systems described herein increase the storage capacity over conventional media library systems while conforming to sizing standards set by various storage facilities. FIGS. 2B and 2C depict a front and top view of the example media library system 100 with dimensions to fit within sizing standards set by storage facilities. The media library system 100 illustrated is configured to fit within an approximately 600 mm width set by a storage facility. As such, the frame 102 has a total width of 606 mm. To enable storage of two media cartridges in one slot, the media storage magazine 132 may be approximately 210 mm to 215 mm (e.g., 213 mm). As such, each magazine opening 103 in the frame has a width approximately the same or slightly larger than media storage magazine 132 to accommodate the width of media storage magazine 132. As such, the width of each magazine opening 103 illustrated has a width of 215 mm. In embodiments with two columns of storage magazines as illustrated, this leaves minimal width for the interior space 104 in which the robotic picker device 150 is to move. For example, in the illustrated embodiment, the width of the interior space 104 is 155 mm. The width of the robotic picker may be substantially similar or slightly less than the width of the interior space 104 so as to be able to move throughout the interior space 104 to retrieve and move various media cartridges throughout the media library system. In some embodiments, the width of the robotic picker device 150 may be 148 mm.

FIG. 3 is a block diagram showing a top view of an example media library system 100 of FIG. 1 for storing one or more media cartridges 110, according to some embodiments. As illustrated, media library system 100 includes frame 102 for supporting one or more other components of media library system 100, media drive system 120, media storage area(s) 130, and media retrieval assembly 140. Although an example layout is illustrated, it can be appreciated that media library system 100 may have any suitable design that is configured to store a plurality of media cartridges 110 and use one or more media drives 122 to read data from and write data to the plurality of media cartridges 110. In some embodiments, to fit within one or more size standards set by a particular storage facility, frame 102 may have one or more dimensions sized according to the size standards. For example, frame 102 may have a particular width set by a particular storage facility (e.g., a width of 600 millimeters). In some embodiments, frame 102 may be rigid and may be at least substantially rectangular in shape, although the technology is not limited in this respect. Frame 102 may be constructed of any number of conventional materials, such as those utilized in industry standard rack mount cabinets.

Media drive system 120 may include one or more media drives 122. The one or more media drives 122 may be configured for reading and/or writing data with respect to the media cartridge 110. The one or more media drives 122 may be arranged in a column in a particular area of the media library system 100 (e.g., a rear portion). The number of media drives 122 provided within the media library system 100 can be varied to suit the specific attributes (e.g., dimensions, media cartridge type, etc.) of media library system 100. For example, in certain embodiments, the media library system 100 can include three media drives 122 that are stacked substantially one on top of another with no or minimal spacing therebetween. Alternatively, the media library system 100 can include greater than three or fewer than three media drives 122 and/or the media drives 122 can be positioned in a different manner relative to one another. For example, in certain non-exclusive alternative embodiments, the media library system 100 can be configured to include one hundred or more media drives 122. Still alternatively, depending on the design of the media library system 100, the media drives 122 can be adapted for use with different types of media, such as tape cartridges, optical drives, hard disk drives, etc.

In certain embodiments, the media library system 100 may include more than a single media drive system 120 for purposes of providing the one or more media drives 122. For example, in some embodiments, the media library system 100 can include a plurality of media drive systems 120, with each media drive system 120 including one or more individual media drives 122. In one embodiment, the media library system 100 can include three individual media drive systems 120, with each media drive system 120 including a single media drive 122, to provide a total of three media drives 122 for the media library 100. Alternatively, the media library system 100 can include any desired number of media drive systems 120 and/or media drives 122.

Media library system 100 includes one or more media storage areas 130 (e.g., media storage areas 130A and 130B) for storing one or more media cartridges 110. Media storage areas 130 may include one or more media cartridge storage magazines 132. The storage magazines 132 may be arranged in one or more columns in storage areas 130. For example, a first column of storage magazines 132 may be disposed in a first storage area 130A and a second column of storage magazines 132 may be disposed in a second storage area 130B, although any suitable arrangement may be used as the technology is not limited in this respect.

Each storage magazine 132 includes one or more media cartridge storage slot 134 for retaining one or more media cartridges 110. The media cartridges 110 may have any suitable design and storage slots 134 may be configured to store the media cartridges 110 of a particular shape, or of multiple different shapes. For example, in some embodiments, the media cartridge 20 can be substantially rectangular box-shaped and storage slots 134. Although four storage slots 134 per storage magazine 132 are illustrated, the technology is not limited in this respect and each storage magazine 132 may have any suitable number of storage slots 134. Each storage slot 134 may be configured to receive and retain a single media cartridge 110. To increase the capacity of the media library, in some embodiments, each storage slot 134 may be configured to receive and retain more than one media cartridge 110 and may arrange the more than one media cartridges 110 in any suitable manner. Each storage slot 134 may include one or more features configured to retain and secure the one or more media cartridges 110 in the slot and facilitate retrieval functions of the media library, including for example, latch 135 and a spring-loaded mechanism (not pictured).

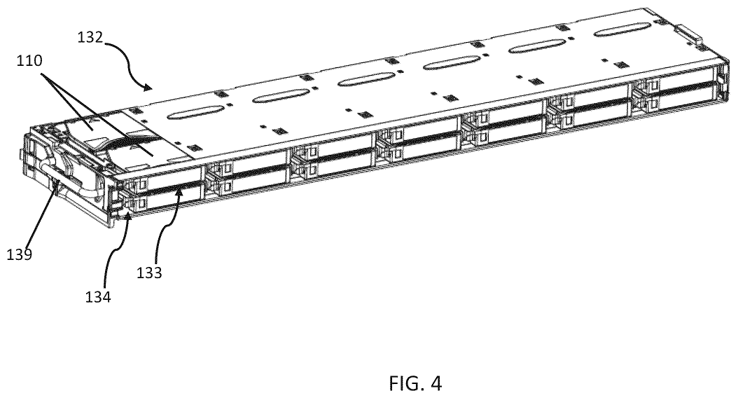

FIG. 4 depicts a perspective view of an example media cartridge storage magazine 132 for use in a media library system, according to some embodiments. Storage magazine 132 includes one or more media cartridge storage slots 134, openings 133, and a handle 139. Handle 139 may be used to insert or retrieve storage magazine 132 from the media library. In the embodiment depicted in FIG. 4, each storage slot 134 is configured to retain more than one media cartridge 110 in the media library. For example, storage slot 134 has a first row having two media cartridges 110 and a second row having another two media cartridges 110 disposed on top of the first row. However, the technology is not limited in this manner and each storage slot may only have one row, or may be configured in any other suitable manner.

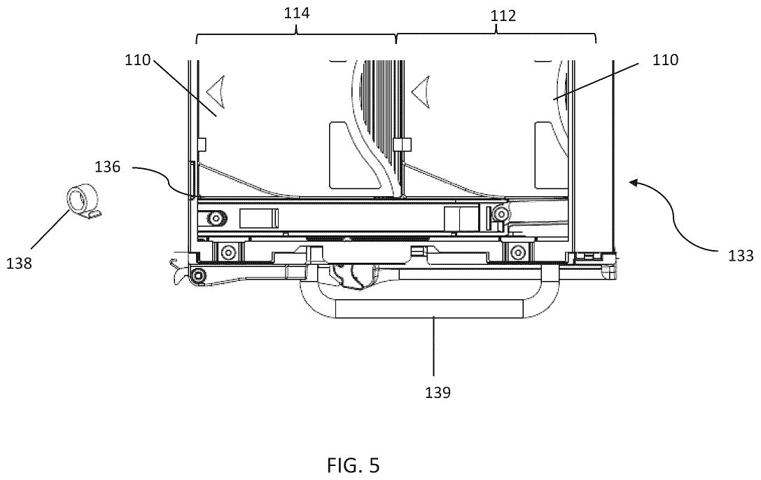

FIG. 5 depicts a cross-sectional view of a portion of an example media cartridge storage magazine 132 of FIG. 4, according to some embodiments. In each row of storage slot 134, one media cartridge 110 is disposed in a first portion 112 and a second media cartridge 110 is disposed in a second portion 114. The first portion 112 of storage slot 134 may be adjacent the opening 133 which is configured to allow access to storage slot 134. The second portion 114 may be a rear portion of storage slot 134 and the second media cartridge 110 may abut a rear wall of storage magazine 132.

The second portion 114 may be accessible through the opening 133 and through the first portion 112 so that a media cartridge 110 being inserted into or retrieved from the second portion 114 may pass through opening 133 and first portion 112. Upon retrieval by a retrieval assembly, the retrieval assembly may reach through opening 133 and first portion 112 to retrieve the second media cartridge 110 from second portion 114. Additionally or alternatively, each storage slot 134 may include a spring-loaded mechanism 136 having spring 138. Spring-loaded mechanism 136 may be configured to bias the second media cartridge 110 stored in the second portion 114 towards first portion 112 and opening 133. In that way, when first portion 112 is empty, spring-loaded mechanism 136 may push the second media cartridge 110 at least partially into first portion 112 for easier retrieval. For example, spring-loaded mechanism 136 may be shaped (e.g., substantially triangularly) to abut a slanted portion in the rear of media cartridge 110, and may provide a biasing force to the slanted portion towards the first portion 112 and opening 133, although the spring-loaded mechanism 136 and the media cartridge 110 may be otherwise shaped or configured to engage in a similar manner. In some embodiments, the spring-loaded mechanism 136 may be disposed behind the second portion 114. However, to increase the available width of the storage slot, some or all of spring-loaded mechanism 136 may be disposed and extend along a side of the storage slot 134. It can be appreciated that storage magazines 132 and storage slots 134 may be configured in any other suitable manner, with any modifications to the designs described herein. For example, in some embodiments, each storage slot may only include one row of media cartridges (rather than two or more stacked rows), In other embodiments, the second portion 114 may not be the most rearward portion, and storage slot 134 may include a third (or more) portions disposed between the second portion 114 and the rear wall of storage magazine 132.

Returning to FIG. 3, media library system 100 includes one or more retrieval assemblies 140 for supporting components that facilitates one or more functions of the media library (e.g., cartridge retrieval). The media retrieval assembly 140 includes an assembly base 142, an assembly guide system 144, an assembly mover system 146, and/or rack assembly 147 for support the media retrieval assembly 140. Media retrieval assembly 140 may be configured to support and facilitate movement of one or more media cartridges 110 throughout the media library system 100 as described herein using robotic picker device 150. As such, retrieval assembly 140 may be positioned in an interior space 104 of media library system 100 so as to provide robotic picker device 150 access to all of the storage slots 134 and media drives 122 in media library system 100. For example, in the illustrated embodiment having two media storage areas 130 disposed on either side of the media library system 100, retrieval assembly 140 may be disposed in a central portion between each media storage area 130 so that robotic picker device 150 may move in the interior space 104 to access media cartridges 110 in each storage slot 134.

In some embodiments, the assembly base 142 may be initially disposed at a bottom of frame 102 of the media library (e.g., as illustrated in FIGS. 1 and 2). In that way, the assembly base 142 may provide support for the robotic picker device 150 as the picker system 150 accesses the media cartridges 110 and moves the media cartridges 110 between the storage slots 134 and the media drives 122. In some embodiments, the assembly base 142 can be a substantially rectangular-shaped plate that is coupled to each of the racks 148 of the rack assembly 147. Alternatively, the assembly base 24A can have another suitable design.

The assembly guide system 144 may be configured to guide movement of the robotic picker device 150 as the picker system 150 moves along the assembly base 142. In some embodiments, as shown, the assembly guide system 144 can include a pair of guide rails 145 that guide the movement of the robotic picker device 150 longitudinally along the assembly base 142. Alternatively or additionally, the assembly guide system 144 may include guide rails perpendicular to guide rails 145 for supporting lateral movement (e.g., between the two media storage areas 130).

The assembly mover system 146 may be configured to move the assembly base 142 along the racks 148 of the rack assembly 147 so as to vertically position the robotic picker device 150 relative to the storage slots 134 and/or the media drives 122. In some embodiments, the assembly mover system 146 can include four individual movers, with one mover being secured to, integrated with, and/or positioned adjacent to each of the corners of the assembly base 142 and also positioned adjacent to one of the racks 148 of the rack assembly 147. In that way, the assembly mover system 146 can maintain the assembly base 142 in a level, horizontal position as the assembly base 142 is moved vertically up and down along the racks 148 of the rack assembly 147. The movers of assembly mover system 146 may include any suitable movement apparatus including, but not limited to, motors, pulleys, belts, or any other suitable movers.

The robotic picker device 150, as noted, may be configured to selectively access the media cartridges 110 and move the media cartridges 110 between the storage slots 134 and the media drives 122. In some embodiments, the retrieval assembly 140 including robotic picker device 150 enables quick and easy retrieval of media cartridge 110 from a storage slot 134. More particularly, in some embodiments, the robotic picker device 150 may include a picker head 152 having one or more slots for receiving a media cartridge 110, one or more picker fingers 156 movable coupled to picker head 152 (e.g. via reach carriage 154) and configured to selectively grasp one of the one or more media cartridges 110, latch deactivator 157 for deactivating latch 135 of storage slot 134 in which the media cartridge 110 is retained, and/or reach motor 158 for moving the picker fingers 156 towards storage slot 134. In some embodiments, latch deactivator 157 may be coupled to or integrally formed with one or both of picker fingers 156, and any other suitable portion of the robotic picker device 150.

During use of the media library system 100, the retrieval assembly 24, such as upon request of a user or host, may be moved toward a particular storage slot 134 for purposes of retrieving a media cartridge 110 therefrom, such as during a process of performing a designated or requested read/write operation. For example, assembly mover system 146 may move the robotic picker device 150 along racks 148 and guide rails 145 so that a slot of picker head 152 is aligned with an opening of the storage slot 134 (e.g., opening 133), Once the robotic picker device 150 is appropriately positioned generally adjacent to the particular storage slot 134, the picker fingers 156 may be moved along guide rails 160 with reach motor 158 relative to the picker head 152 from a retracted position, where the picker fingers 156 are not positioned near the particular storage slot 134, to a first extended position, where the picker fingers 156 are positioned near the particular storage slot 134 but cannot yet grasp the media cartridge 110 retained within the particular storage slot 134. When the picker fingers 156 are so positioned near the particular storage slot 134 in the first extended position, the picker fingers 156 can be moved from a first (closed) position to a second (open) position.

Once the picker fingers 156 have been moved to the second (open) position, the robotic picker device 150 may further move the picker fingers 156 (e.g., with reach motor 158) from the first extended position to a second extended position so that the picker fingers 156 are positioned directly adjacent to the particular storage slot 134 and/or the media cartridge 110. With the picker fingers 156 positioned in the second extended position directly adjacent to the storage slot 134, the picker fingers 156 can then be moved into a third (engaged) position and gradually engage opposing sides of the media cartridge 110.

As the picker fingers 156 are being moved to the third (engaged) position, the latch deactivator 157 may gradually push the latch 135 into a deactivated position so that the media cartridge 110 can be accessed and removed from the particular storage slot 134. In the deactivated position, latch 135 may be moved so that it is no longer blocking removal of the media cartridge 110 from the storage slot 134. In certain embodiments, movement of the latch 19 between the activated position and the deactivated position entails rotational movement of the latch 135 so that latch 135 is no longer blocking removal of media cartridge 110. It can be appreciated that in some embodiments having a dual-or multi-cartridge storage slot 134, media cartridges 110 stored in the second portion (or third, or fourth, etc.) position may not be directly adjacent the opening 133 of storage slot 134. As such, the various positions described above may be extended so that picker fingers 156 may extend deeper into storage slot 134 to be properly positioned adjacent the second media cartridges 110 for engagement and retrieval. Alternatively or additionally, after removal of the first media cartridge from the first portion of the storage slot 134, the spring-loaded mechanism 136 (e.g., as pictured in FIG. 5) may push the second media cartridge 110 at least partially into the first position. In that way, the various positions of robotic picker device 150 described above may not be extended to reach media cartridges in the second portion. It can be appreciated that retrieval assembly 140 and robotic picker device 150 may be configured to similarly re-insert the media cartridge 110 into the storage slot 134 (e.g., after the read/write operation is completed). The retrieval assembly 140 and robotic picker device 150 may re-insert the media cartridge 110 into storage slot 134 in a similar manner as described above. However, the sequence of positions described above may be reversed for inserting the media cartridge 110 into storage slot 134.

It can be appreciated that, when retrieving a media cartridge 110 from a rear portion of a storage slot 134 (e.g., second portion 114), the media cartridge 110 stored in a forward portion of the storage slot 134 (e.g., first portion 112) may be retrieved. In some embodiments, the robotic picker device 150 may include a single slot for receiving media cartridges. As such, the first media cartridge 110 may be moved to a separate storage location (e.g., an intermediary storage location or another storage slot 134) while the second media cartridge 110 is being retrieved.

However, the inventors have recognized that it may be beneficial to provide a system for retrieving the media cartridge stored in the rear portion of the storage slot while minimizing any excess movement. As such, in some embodiments, the robotic picker device 150 for use in retrieval assembly 140 may be a dual-slot robotic picker device. In that way, the robotic picker device may retrieve the first media cartridge 110 and hold the first media cartridge in the first slot, while the second media cartridge 110 in the rear portion is being received and retained in the second slot of the dual-slot robotic picker device to minimize movement of the retrieval assembly between the storage slot 134 and any intermediary or other storage.

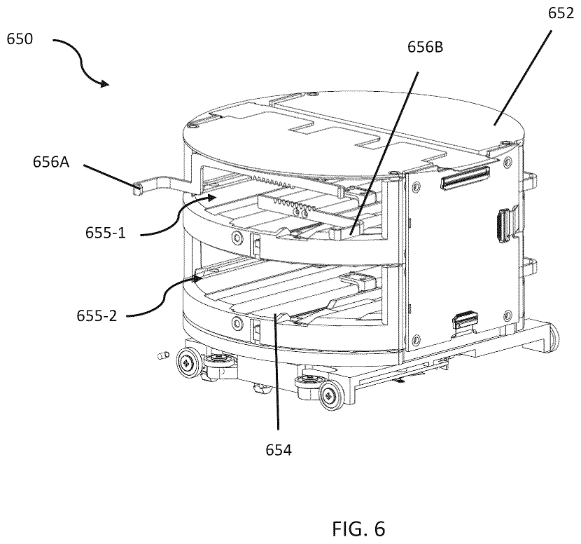

FIG. 6 depicts an example dual-slot robotic picker device 650 for use in a media library system, according to some embodiments. Dual-slot robotic picker device 650 includes a picker head 652 having two or more slots 655. In some embodiments, each slot 655 may include a reach carriage 654 and one or more picker fingers 656A and 656B. The reach carriage 654 and one or more picker fingers for each slot 655-1 and 655-2 may be operated in a similar manner as described above with respect to retrieval assembly 140 and robotic picker device 150. In some embodiments, the first slot 655-1 may be configured to retrieve and retain the media cartridge 110 from the first portion of the storage slot 134, whereas the second slot 655-2 may be configured to retrieve and retain the media cartridge 110 from the second portion of storage slot 134. As such, the reach carriage 654 and picker fingers 656A and 656B of the second slot may be configured to extend further into the storage slot 134 than the reach carriage 654 and picker fingers 656A and 656B of the first slot. In other embodiments, the dual-slot robotic picker device 650 may only have one set of a reach carriage 654 and picker fingers 656 that may be configured to retrieve both the first and second media cartridges from the storage slot 134 and insert them into their respective slots.

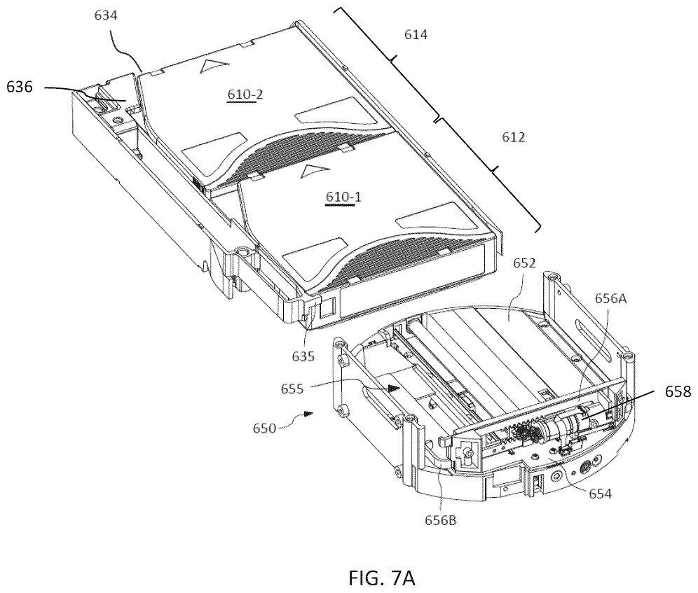

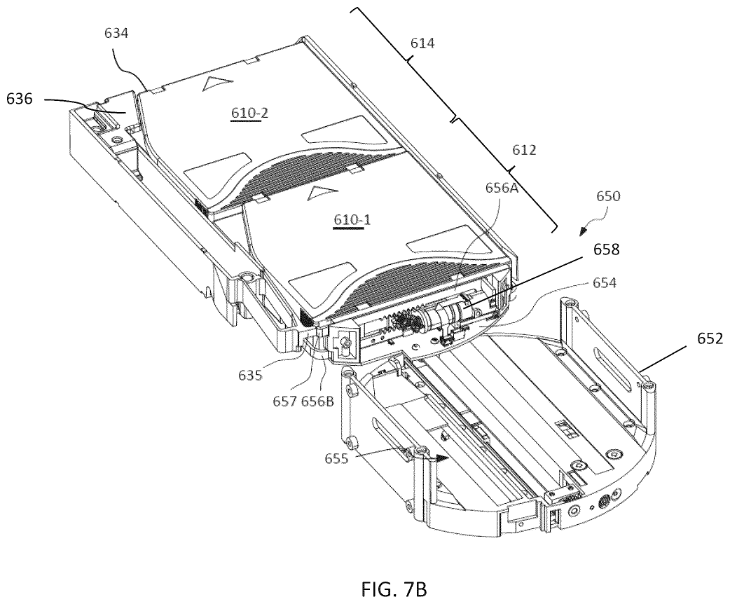

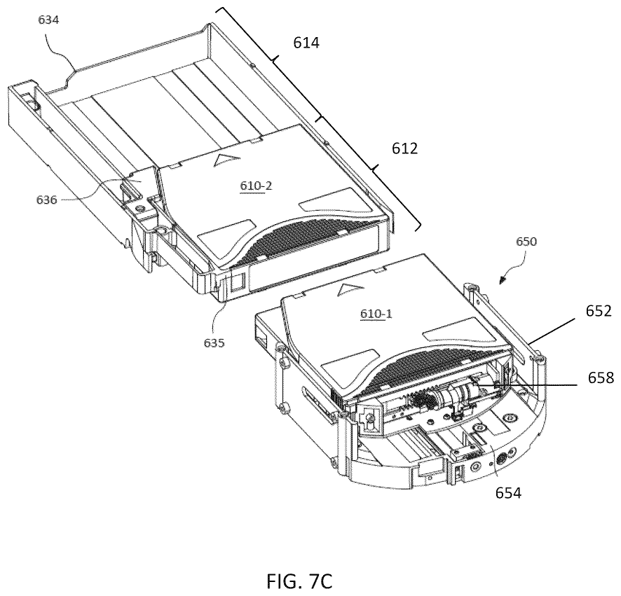

FIGS. 7A-7C depict various positions of the robotic picker device (e.g., picker device 650) retrieving a media cartridge 610 from a first portion 612 of a dual-cartridge storage slot 634. In the figures, the top portion of robotic picker device 650 has been removed for clarity and visibility.

FIG. 7A depicts a perspective view of a media cartridge storage slot and a robotic picker device in a first position with picker fingers in a closed position, according to some embodiments, In the first position, picker fingers 656A and 656B may be in a closed positioned and retained within slot 655 of picker head 652. For example, picker fingers 656A and 656B may be secured to reach carriage 654 which may, in the first position, be retained in slot 655, During retrieval of a media cartridge 610 from storage slot 634, picker fingers 656A and 656B may be moved from the closed position to an open position and reach carriage 654 may be moved at least partially out of slot 655 so that the picker fingers may engage media cartridge 610. For example, reach motor 658 may move reach carriage 654 along a guide rail (not pictured) of robotic picker device 650 towards storage slot 634.

While the robotic picker device 650 is in the first position, storage slot 634 may include latch 635 in an activated position on a first side of the storage slot 634 adjacent the robotic picker device 650 and a spring-loaded mechanism 636 disposed on a second side of storage 634 opposite the first side further from the robotic picker device 650. Spring-loaded mechanism 636 may be configured to bias the second media cartridge 610-2 stored in second portion 614 towards the first side of the storage slot 634. For example, spring-loaded mechanism 636 may engage with a portion of media cartridge 610-2 adjacent the second side with a biasing force. Being in the activated position, latch 635 may secure the media cartridges 610-1 and 610-2 from being pushed out of storage slot 634 due to the biasing force from spring-loaded mechanism 636.

FIG. 7B depicts a perspective view of a media cartridge storage slot and a robotic picker device in a second position with picker fingers engaged with a first media cartridge, according to some embodiments. In the second position, reach motor 658 has moved reach carriage 654 out of slot 655 and towards storage slot 634. In that way, picker fingers 656A and 656B may reach and engage with the first media cartridge 610-1 stored in the first portion 612 of storage slot 634.

After being placed in the second position, picker fingers 656A and 656B may be moved from the open position to an engaged position to securely engage and grab first media cartridge 610-1.

In moving the reach carriage 654 and picker fingers 656A and 656B to the second position, latch deactivator 657—disposed on a first side of picker finger 656A in the illustrated embodiment—may engage with latch 635 to push latch 635 from the activated position to a deactivated position. Deactivating latch 635 may be done in any suitable manner. For example, in some embodiments, latch 635 and latch deactivator 657 may be shaped analogously so that, in moving the reach carriage 654 and picker fingers 656A and 656B to the second position, the latch deactivator 657 may engage with and slide against latch 635 so that latch 635 is pushed to the deactivated position. Additionally or alternatively, in some embodiments as in the illustrated embodiment, latch deactivator 657 may extend from a first side of a picker finger (e.g., picker finger 656A). Moving the picker finger 656A from an open position to an engaged position as described above may cause the latch deactivator 657 to push latch 635 from the activated position to the deactivated position so that media cartridge 610-1 may be retrieved. It can be appreciated that latch deactivator 657 may not be disposed on a picker finger 656A, and may be disposed on any portion of the robotic picker device 650 (e.g., reach carriage 654, picker finger 656B, etc.) that may allow latch deactivator 657 to engage with latch 635.

FIG. 7C depicts a perspective view of a media cartridge storage slot and a robotic picker device in a third position with the first media cartridge being received into a first slot of the robotic picker device, according to some embodiments. In the third position, reach motor 658 retracts reach carriage 654 back into slot 655 of robotic picker device 650. With picker fingers 656A and 656B in the engaged position, retracting reach carriage 658 back into slot 655 additionally pulls first media cartridge 610-1 into slot 655. In retracting reach carriage 654 and picker fingers 656A and 656B back into slot 655, latch deactivator 657 may disengage from latch 635. However, latch 635 may not immediately return to the activated position. Rather, an adjacent side of first media cartridge 610-1 may prevent latch 635 from returning to the activated position until media cartridge 610-1 is removed from storage slot 634. For example, latch 635 may slide along the adjacent side of media cartridge 610-1 as it is being retrieved. Media cartridge 610-1 may include a rearward slanted portion. When the latch 635 slides along the slanted portion of media cartridge 610-1, latch 635 may slowly be placed back into the activated position.

Additionally, in some embodiments, for example, embodiments with spring-loaded mechanism 636, retrieving first media cartridge 610-1 may cause second media cartridge 610-2 to be moved from second portion 614 at least partially to first portion 612. For example, spring-loaded mechanism 636 may push second media cartridge 610-2 towards first portion 612 as first media cartridge 610-1 is being removed. As the latch 635 is returned to the activated position via the slanted portion of first media-cartridge 610-1, latch 635 may engage with the second media cartridge 610-2 so that spring-loaded mechanism 636 does not push second media cartridge 610-2 out of storage slot 634. In that way, the second media cartridge 610-2 may be retrieved in a similar manner as to first media cartridge 610-1, either into a second slot of robotic picker device 650 or after first media cartridge 610-1 is placed into an intermediary storage area. Additionally or alternatively, reach carriage 654 may be configured to extend deeper into storage slot 634 so as to retrieve second media cartridge 610-2 from second portion 614, or in circumstances where second media cartridge 610-2 is only partially pushed into first portion 612.

To re-insert a media cartridge into the storage slot 634, the reverse sequence of positions described with respect to FIGS. 7A-C may be performed. For example, reach motor 658 may push reach carriage 654 towards storage slot 634 while holding first media cartridge 610-1. Reach carriage 654 and first media cartridge 610-1 may push second media cartridge 610-2 back into second position 614. In doing so, latch 635 may slide into the deactivated position along the adjacent side of first media cartridge 610-1 until it engages with latch deactivator 657 when first media cartridge 610-1 is inserted. Picker fingers 656A and 656B may then be moved into the open position to disengage from first media cartridge 610-1. In some embodiments, disengaging the picker fingers may similarly disengage latch deactivator 657 from latch 635 so as to place latch 635 back into the activated position to secure first media cartridge 610-1 back in the first portion 612 of storage slot 634.

Returning to FIG. 3, in order to fit within size standards of a particular storage facility, the retrieval assembly 140 and robotic picker device 150 may operate within a tight interior space 104 of the frame 102. As such, the robotic picker device 150 may have features that enable movement within the tight interior space 104. For example, as depicted in FIG. 6 with respect to dual-slot robotic picker device 650, picker head 652 may be substantially circular in shape so that picker head 652 may rotate between various orientations within the interior space 104 without interacting with other components of media library system 100. For example, when retrieving or re-inserting the media cartridge 110 into a storage slot 134, the picker head 652 may be rotated to a first orientation in which a slot (e.g., 655-1 or 655-2) is aligned with an opening 133 of the storage slot 134. When inserting or retrieving the media cartridge 110 from a media drive 122, the picker head 652 may be rotated to a second orientation in which a slot is aligned with the media drive 122. The picker heads of the robotic picker devices described herein may be rotatable into any suitable orientation including the first and second orientations described above, a third orientation so that a slot is aligned with a storage slot 134 of a different media storage area 130.

It can be appreciated that the media library system 100 may not be limited to a single retrieval assembly 140 and robotic picker device 150. Media library system 100 may include two or more retrieval assemblies 140. For example, media library system 100 may include a first retrieval assembly 140 for moving media cartridges 110 from a first media storage portion 130 and a second retrieval assembly 140 for moving media cartridges 110 from a second media storage portion 130. The two retrieval assemblies 140 may be positioned adjacent to each other. Alternatively or additionally, media library system 100 may include two or more retrieval assemblies 140 stacked on top of each other.

In some embodiments, media library system 100 may additionally have one or more features for supporting the functionality of the media library system 100, disposed within and supported by frame 102. For example, media library system 100 may include a power supply 106 and a controller 108 disposed within the frame. However, the technology is not limited in this respect and power supply 106 and controller 108 may be disposed separately from frame 102 and may be operatively coupled (via wired or wireless means) to media library system 100. Additionally or alternatively, media library system 100 may include a graphical user interface to facilitate interaction between and operation of the media library system 100 and a user.

The power supply 106 may provide electrical power in a well-known manner to the one or more media drives 122, the retrieval assembly 140, the controller 108, a graphical user interface for interacting with the media library system 100, and/or additional media library systems 100. The power supply 106 can be interfaced with these components as well as with an external power source in a well-known manner using industry-standard cabling and connections. Alternatively, the power supply 106 can be interfaced with these components in another manner.

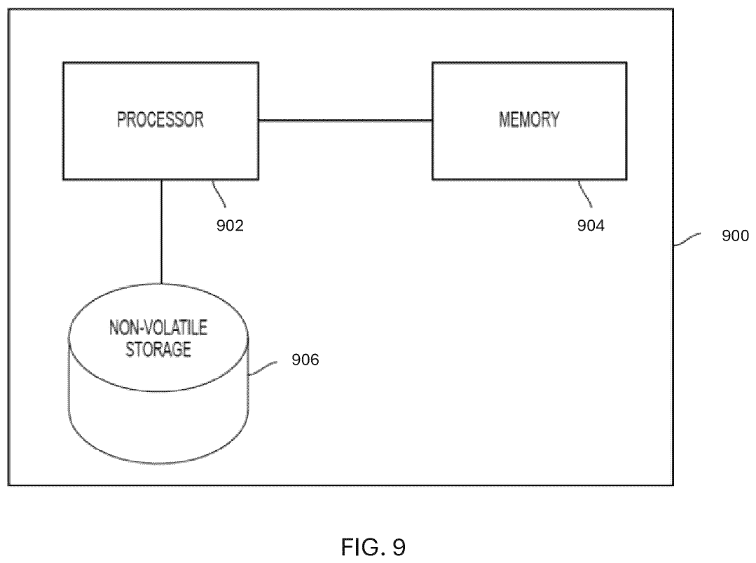

The controller 108 may provide various controls for overseeing and controlling the functionality of the media library system 100. The controller 108 can have any suitable design, many of which are well-known in the industry. For example, in some embodiments, the controller 108 can include a standard driver interface unit for receiving digital commands and translating the commands into driving currents, such as step pulses for controlling stepper motors. In another embodiment, the controller 108 can include a standard programmable general-purpose computer (e.g., as described with respect to FIG. 9) formed on a single plug-in card unit and can include a programmed microprocessor or microcontroller, memory, communication interface, control interface, connectors, etc. Alternatively, the controller 108 may have a different design and/or the controller 108 can be positioned within the media library 10 in a different position or manner than that illustrated in FIG. 3.

The media library 10 can use well-known industry standard cabling and communication protocols between the controller 108 and other structures of the media library system 100. Cabling and electrical characteristics including signaling protocols can be generally standardized, and the logical message protocols can be either proprietary or standardized as known to those skilled in the art. Alternatively or additionally, controller 108 may be configured to communicate with other components and structures of media library system 100 via a wireless communication protocol (e.g., WiFi, Bluetooth, etc.).

FIG. 8 is a flow chart for an illustrative process 800 of retrieving a media cartridge from a media cartridge storage slot of a media library, according to some embodiments. Process 800 begins, at step 802, by retrieving, using a robotic picker device (e.g., robotic picker device 150 or 650) a first media cartridge from the first portion of a dual-cartridge storage slot and receive the first media cartridge into a first slot of the robotic picker device. For example, as described above with respect to FIG. 3, assembly mover system 146 may move the robotic picker device 150 so that the first slot is aligned with the opening (e.g., 133) of a storage slot 134. The robotic picker device 150 may retrieve the first media cartridge (e.g., media cartridge 610-1) from storage slot 134 as described with respect to FIGS. 7A-C, and hold the first media cartridge in the first slot.

As step 804, process 800 proceeds by moving the robotic picker device so that a second slot of the robotic picker device is aligned with the dual-cartridge storage slot. For example, in some embodiments, the robotic picker device may be robotic picker device 650 of FIG. 6. Robotic picker device 650 may receive the first media cartridge received at step 802 in slot 655-1. Assembly mover system 146 may then move robotic picker device 650 so that slot 655-2 is aligned with the storage slot 134 (e.g., aligned with opening 133 of storage slot 134). However, it can be appreciated that in some embodiments, both slot 655-1 and 655-2 may be configured in a similar manner and can retrieve the first media cartridge interchangeably.

At step 806, process 800 then proceeds by retrieving, with the robotic picker device a second media cartridge from the dual-cartridge storage slot and receive the second media cartridge into the second slot of the robotic picker device. In some embodiments, as described above, the second slot may have a respective reach carriage (e.g., reach carriage 650) and picker arms that may be configured to reach further into the storage slot, so that the second media cartridge may be retrieved from a second portion of the storage slot. However, the technology is not limited in this respect. Rather, additionally, or alternatively, in some embodiments, having retrieved the first media cartridge from the storage slot, the second media cartridge in the storage slot (e.g., second media cartridge 610-2) may be at least partially pushed from the second portion of the storage slot to the first portion of the storage slot. In that way, the reach carriage and the picker arms of the second slot do not need to extend as deep into the storage slot. With either configuration, the second media cartridge may be received in a similar manner as to the first media cartridge as described above with respect to FIGS. 7A-7C.

Optionally, process 800 may proceed at steps 808 and 810 to move the robotic picker device so that the first slot of the robotic picker device is again aligned with the dual-cartridge storage slot and insert the first media cartridge back into the first portion of the dual-cartridge storage slot. For example, reinserting the first media cartridge back into the storage slot so that the robotic picker device does not need to move back to the storage slot to return the first media cartridge that is not being used in the media drives. However, in some embodiments, the second media cartridge retrieved may only be used by a media drive for a brief period. As such, the first media cartridge may be held by the robotic picker device until the conclusion of process 800. In that way, process 800 may minimize subsequent robotic picker device moves by either including or excluding steps 808 and 810.

Process 800 proceeds at step 812 to move the robotic picker device so that the second slot of the robotic picker device is aligned with a first media drive. Moving the robotic picker device from the storage slot to the media drives may involve vertical, lateral, longitudinal, and rotational movement of the robotic picker device. For example, an assembly mover system 146 as described with respect to FIG. 3 may move the robotic picker assembly laterally between media storage areas, longitudinally along the length of the media library, and vertically along the racks between rows of storage slots and media drives. The robotic picker device may include a rotatable head that can rotate between various orientations and moving the robotic picker device so that the second slot of the robotic picker device is aligned with the first media drive may comprise rotating between a first orientation where the slot is facing a media storage area and a second orientation where the slot is facing the media drives.

After the second slot is properly aligned with the first media drive, at step 814 process 800 proceeds by inserting the second media cartridge into the first media drive. Robotic picker device may insert the second media cartridge into the first media drive by any suitable method.

For example, as described above, the robotic picker device may insert media cartridges following the insertion process described with respect to FIGS. 7A-C. The reach motor may move the reach carriage forward towards the media drive. Once the second media cartridge is inserted, the picker fingers may disengage from the second media cartridge into the open position. The reach motor may retract the reach carriage back into the second slot and the picker fingers may be moved to a closed position.

After use of the media cartridge by the media drives, the second media cartridge may be returned to the storage slot. In some embodiments, when returning the media cartridge to the storage slot after use by the media drives, the orientation of the two media cartridges in the storage slot may be switched so that the second media cartridge is subsequently stored in the first portion of the storage slot and the first media cartridge is stored in the second portion. In other embodiments, the first media cartridge may be retrieved by the robotic picker device prior to returning the second media cartridge back to the storage slot so the orientation remains the same.

FIG. 9 shows a block diagram of an example computing device 900 that may be used to implement embodiments of the technology described herein. For example, controller 108 of FIG. 3 may be implemented as computer system 900. The computing device 900 includes one or more computer hardware processors 902 and non-transitory computer-readable storage media (e.g., memory 904 and one or more non-volatile storage devices 906). The processor(s) 902 may control writing data to and reading data from (1) the memory 904; and (2) the non-volatile storage device(s) 906. To perform any of the functionality described herein, the processor(s) 902 may execute one or more processor-executable instructions stored in one or more non-transitory computer-readable storage media (e.g., the memory 904), which may serve as non-transitory computer-readable storage media storing processor-executable instructions for execution by the processor(s) 902.

The computing device 900 may be a portable computing device (e.g., a smartphone, a tablet computer, a laptop, or any other mobile device), a computer (e.g., a desktop, a rack-mounted computer, a server, etc.), or any other type of computing device. The portable computing device may be operatively coupled to one or more components of the media library, e.g. over a communication network using a wireless communication protocol.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

The terms “approximately” and “about,” or any similar term, may be used to mean within ±20% of a target value in some embodiments, within ±10% of a target value in some embodiments, within ±5% of a target value in some embodiments, within ±2% of a target value in some embodiments. The terms “approximately”and “about”may include the target value.

Having described several embodiments of the techniques described herein in detail, various modifications, and improvements will readily occur to those skilled in the art. Such modifications and improvements are intended to be within the spirit and scope of the disclosure, Accordingly, the foregoing description is by way of example only, and is not intended as limiting. The techniques are limited only as defined by the following claims and the equivalents thereto.

What is claimed is:

1. A media library system, the system comprising:
a frame;
a media storage portion supported by the frame, the media storage portion comprising:
a first column of media cartridge storage magazines, and
a second column of media cartridge storage magazines,
wherein media cartridge storage magazines in the first column and the second column comprise multiple dual-cartridge storage slots configured to receive two media cartridges;
a media drive portion supported by the frame, the media drive portion comprising a plurality of media drives, each media drive of the plurality of media drives being configured to read data from a media cartridge when the media cartridge is inserted into the media drive; and
a robotic picker device supported by the frame and configured to move in an interior space of the media library and selectively retrieve a media cartridge stored in the media storage portion and place the media cartridge into one of the plurality of media drives, the robotic picker device comprising:
a first slot configured to receive a first media cartridge and a second slot configured to receive a second media cartridge.

2. The media library system of claim 1, wherein the robotic picker device is disposed between the first column and the second column.

3. The media library system of claim 2, wherein the first slot is disposed on a first side of a rotatable head of the robotic picker device and configured to receive a media cartridge, the rotatable head being configured to rotate between a first orientation in which the first side is facing the first column, a second orientation in which the first side is facing the second column, and a third orientation in which the first side is facing the plurality of media drives.

4. The media library system of claim 1, wherein each dual-cartridge storage slot comprises a spring-loaded mechanism configured to bias the second media cartridge in the second portion towards the first portion,

5. A media library system, the system comprising:
a frame;
a media storage portion supported by the frame, the media storage portion comprising:
at least one column of media cartridge storage magazines, wherein at least some of the storage magazines comprise multiple dual-cartridge storage slots;
a media drive portion supported by the frame, the media drive portion comprising a plurality of media drives, each particular drive of the plurality of media drives being configured to read data from a media cartridge when the media cartridge is inserted into the particular drive; and
a robotic picker device supported by the frame and configured to selectively retrieve a media cartridge stored in the media storage portion and place the media cartridge into one of the plurality of media drives.

6. The media library system of claim 5, wherein the at least one column of media cartridge storage magazines comprises:
a first column of media cartridge storage magazines, each comprising multiple dual-cartridge storage slots; and
a second column of media cartridge storage magazines, each comprising multiple dual-cartridge storage slots,

7. The media library system of claim 6, wherein the robotic picker device is disposed between the first column of media cartridge storage magazines and the second column of media cartridge storage magazines,

8. The media library system of claim 7, wherein:
the robotic picker device is configured to move in an interior space of the media library,
openings of dual-cartridge storage slots in the first column of media cartridge storage magazines, through which media cartridges pass during retrieval or placement in the dual-cartridge storage slots, are facing the interior space,
openings of dual-cartridge storage slots in the second column of media cartridge storage magazines, through which media cartridges pass during retrieval or placement in the dual-cartridge storage slots, are facing the interior space, and
openings of the plurality of media drives, through which media cartridges pass during retrieval or placement in the media drives, are facing the interior space.

9. The media library system of claim 5, wherein the robotic picker device has a rotatable head having a slot on a first side of the rotatable head and configured to receive a media cartridge, wherein the rotatable head is configured to rotate between a first orientation in which the first side is facing the first column, a second orientation in which the first side is facing the second column, and a third orientation in which the first side is facing the plurality of media drives.

10. The media library system of claim 7,
wherein the frame has a front end and a back end, and
wherein the frame has a plurality of magazine openings extending from the front end to the back end and configured to receive respective media cartridge storage magazines.

11. The media library system of claim 5, wherein the robotic picker device has two slots to hold two media cartridges.

12. The media library system of claim 5, wherein each dual-cartridge storage slot comprises a first portion configured to retain a first media cartridge and a second portion configured to retain a second media cartridge, the second portion being accessible through the first portion.

13. The media library system of claim 12, wherein each dual-cartridge storage slot comprises a spring-loaded mechanism configured to bias the second media cartridge in the second portion towards the first portion.

14. The media library system of claim 13, wherein each dual-cartridge storage slot comprises a latch configured to engage the first media cartridge.

15. The media library system of claim 5, wherein a width of the frame is about 600 millimeters.

16. A method performed by a media library system, the media library system comprising a plurality of media cartridge storage magazines arranged in at least one column, with at least some of the storage magazines having multiple dual-cartridge storage slots configured to receive media cartridges, one or more media drives, a robotic picker device, the method comprising:
moving, with the robotic picker device, a first media cartridge from a first dual-cartridge storage slot into a first slot of the robotic picker device, the first media cartridge being in a first portion of the first dual-cartridge storage slot;
moving the robotic picker device to align a second slot of the robotic picker device with the first dual-cartridge storage slot;
moving, with the robotic picker device, a second media cartridge from the first dual-cartridge storage slot into the second slot of the robotic picker device, the second media cartridge being in a second portion of the first dual-cartridge storage slot;
moving the robotic picker device to align the second slot with a first media drive of the one or more media drives; and
moving, with the robotic picker device, the second media cartridge into the first media drive of the one or more media drives.

17. The method of claim 16, further comprising:
after retrieving the second media cartridge,
moving the robotic picker device to align the first slot with the first dual-cartridge storage slot; and
moving, with the robotic picker device, the first media cartridge into the first portion of the dual-cartridge storage slot.

18. The method of claim 16, further comprising:
moving, with a spring-loaded mechanism, the second media cartridge at least partially into the first portion of the storage slot after the first media cartridge is removed.

19. The method of claim 18, wherein the first dual-cartridge storage slot comprises a latch configured to engage the first media cartridge, and wherein retrieving the first media cartridge comprises:
placing, with the robotic picker device, the latch into an unlatched position so the spring-loaded mechanism biases the first and second media cartridges towards the robotic picker device.

20. The method of claim 16, wherein the robotic picker device comprises a rotatable head having the first slot and the second slot on a first side of the rotatable head, and wherein moving the robotic picker device to be aligned with the first media drive comprises rotating the rotatable head until the first side is facing the first media drive.
